(19) United States
(12) Patent Application Publication
(10) Pub. No.: US 2005/0058868 A1
(43) Pub. Date: Mar. 17, 2005

(54) Cooling system for fuel cell and method for detecting deterioration of impurity removing member of cooling system for fuel cell

(76) Inventor: Masayuki Taga, Bisai-shi (JP)

Correspondence Address: KENYON & KENYON, 1500 K STREET, N.W., SUITE 700, WASHINGTON, DC, 20005, US

(21) Appl. No.: 10/929,551

(22) Filed: Aug. 31, 2004

(30) Foreign Application Priority Data
Sep. 16, 2003 (JP) 2003-322642

(51) Int. Cl. H01M 8/04

(52) U.S. Cl. 429/26; 429/22; 429/90

(57) ABSTRACT

A cooling system for a fuel cell includes a cooling medium which cools the fuel cell, an impurity removing member which removes impurities in the cooling medium, a container which houses the impurity removing member, and a detecting device which detects deterioration of the impurity removing member.

### INCORPORATION BY REFERENCE

The disclosure of Japanese Patent Application No. 2003-322642 filed on Sep. 16, 2003, including the specification, drawings and abstract is incorporated herein by reference in its entirety.

### BACKGROUND OF THE INVENTION

1. Field of the Invention

The invention relates to a cooling system for a fuel cell, including an impurity removing member which removes impurities in a cooling medium for a fuel cell. The invention also relates to a method for detecting deterioration of an impurity removing member of the cooling system for a fuel cell.

2. Description of the Related Art

A fuel cell, e.g., a polymer electrolyte fuel cell, is constituted by stacking cells each of which includes a MEA (i.e., Membrane-Electrode Assembly) and a separator. The MEA has an electrolyte membrane interposed between an anode and a cathode. In order to suppress a temperature of the fuel cell from exceeding an allowable temperature due to heat generated by electric power generation reaction, a coolant flows between the cells, and the fuel cell is thus cooled. The coolant (water) is circulated in a coolant system including the fuel cell, a coolant tank, a heat exchanger, a circulating pump and the like, and a temperature thereof is adjusted to an appropriate value.

In order to allow the cell to output a predetermined voltage, separators provided opposite sides of the membrane need to be electrically insulated from each other. The separators provided opposite sides of the membrane must not be electrically conducted to each other when the coolant flows through a manifold in the fuel cell stack. Accordingly, impurities in the coolant need to be removed. An impurity removing device usually includes an impurity removing member, e.g., an ion exchange resin and a filter.

However, when the impurity removing member deteriorates, the amount of impurities in the coolant increases, and power generating performance of the fuel cell is reduced. Accordingly, a degree of deterioration of the impurity removing member needs to be detected.

When an ion exchange resin is used as an impurity removing member of an impurity removing device, the following problems arise.

(I) When an ion exchange resin is mounted in a fuel cell vehicle in order to purify generated water or maintain a low electrical conductivity of a coolant, it is difficult to vertically place a container of an impurity removing device and allow the coolant to flow in a direction from top to bottom because of constraints on a space for the ion exchange resin, mountability, serviceability, flowability of the coolant, and the like. If the container is vertically placed and the coolant is made to flow in the direction from bottom to top, or the container is horizontally placed, a clearance is produced in a lower portion or side portion of the container when the coolant flows (i.e., the clearance is not produced in the upper portion of the container). Accordingly, separation, crushing, and partial demineralization of a resin are likely to occur.

(II) When an ion exchange resin is mounted in a fuel cell vehicle, the ion exchange resin is subject to an external force, e.g., a vehicle vibration. Therefore, the resin is likely to be suspended compared with the case where a stationary impurity removing device is employed. Accordingly, separation, crushing, and partial demineralization of a resin are likely to occur.

Japanese Patent Laid-Open Publication No. 2001-35519 (JP-A-2001-35519) discloses an impurity removing device which is provided in a coolant system of a fuel cell and which suppresses occurrence of separation, crushing, and partial demineralization of an ion exchange resin. The impurity removing device disclosed in the publication is a cartridge type, and includes a spring for pressing the ion exchange resin in an axial direction of a container (i.e., a direction in which a coolant flows).

However, the impurity removing device disclosed in Japanese Patent Laid-Open Publication No. 2001-35519 does not include a detecting device which detects deterioration of the ion exchange resin. Therefore, it is difficult to determine whether the ion exchange resin has reached the end of its life (i.e., whether the ion exchange resin needs replacing).

### SUMMARY OF THE INVENTION

It is an object of the invention to provide a cooling system for a fuel cell, which can easily determine a degree of deterioration of an impurity removing member, and a method thereof.

A first aspect of the invention relates to a cooling system for a fuel cell, including a cooling medium which cools the fuel cell, an impurity removing member which removes impurities in the cooling medium, a container which houses the impurity removing member, and a detecting device which detects deterioration of the impurity removing member.

The cooling system includes the detecting device which detects deterioration of the impurity removing member. Accordingly, the degree of deterioration of the impurity removing member can be easily determined, compared with the case where the cooling system does not include the detecting device.

The description, “change in size due to deterioration”, in the invention includes a change in size of the impurity removing member (e.g., the ion exchange resin and a filter), a change in shape of the impurity removing member from an initial shape (i.e., a shape when the device is new), a change in position of the impurity removing member from an initial position in the container, an amount of movement due to the change in position, a change in weight of the impurity removing member from an initial state, and a change in physical parameter of the impurity removing member related to the change in size thereof. Among these changes, not only one but also two or more changes may be detected. The physical parameter may be information which can be obtained by detecting a state of the cooling medium passing through the impurity removing member (e.g., the ion exchange resin and the filter). The state of the cooling medium may be detected based on, for example, a state of electrical conductivity of the cooling medium (i.e., the amount of ion), a flow quantity, a pressure and a flow rate of the cooling medium on the downstream side of the impurity removing member. Also, not only the state of the cooling medium on the downstream side of the impurity removing member but also the state of the cooling medium on the upstream side of the impurity removing member may be detected. These states may be compared with the state of the cooling medium on the downstream side of the impurity removing member.

A “display device which indicates deterioration of an impurity removing member” in the invention includes a structure in which a change due to deterioration of the impurity removing member can be visually checked directly or indirectly from the outside of the container, a sensor which is provided in the container and which detects a physical change due to deterioration of the impurity removing member, and a device which indicates the information from the sensor using light by means of a lamp or a display via an electric signal, or outputs the information from the sensor by sound

A second aspect of the invention relates to a cooling system for a fuel cell, including a cooling medium which cools the fuel cell, an impurity removing member which removes impurities in the cooling medium, housing means for housing the impurity removing means, and detecting means for detecting deterioration of the impurity removing means.

A third aspect of the invention relates to a method for detecting deterioration of an impurity removing member of a cooling system for a fuel cell. In the method, deterioration of the impurity removing member is detected by detecting a change in at least one of size of the impurity removing member, color of the impurity removing member, electrical conductivity of the cooling medium, a flow quantity of the cooling medium, a pressure of the cooling medium, and a flow rate of the cooling medium, which occurs due to deterioration of the impurity removing member.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a cross sectional view of an impurity removing device according to a first embodiment;

FIG. 2 is a cross sectional view of an impurity removing device according to a second embodiment;

FIG. 3 is a cross sectional view of an impurity removing device according to a third embodiment;

FIG. 4 is a cross sectional view of an impurity removing device according to a fourth embodiment;

FIG. 5A is a cross sectional view of an impurity removing device according to a fifth embodiment;

FIG. 5B is a cross sectional view of an impurity removing device according to a modified example of the fifth embodiment;

FIG. 6 is a cross sectional view of an impurity removing device in which a pushing member includes only a movable cap;

FIG. 7 is a cross sectional view of an impurity removing device in which impurity removing members are provided at plural portions in a container;

FIG. 8 is a view schematically showing a cooling system for a fuel cell, according to the first embodiment; and

FIG. 9 is a view schematically showing a cooling system for a fuel cell, according to a modified example of the third embodiment.

### DETAILED DESCRIPTION OF THE PREFERRED EMBODIMENTS

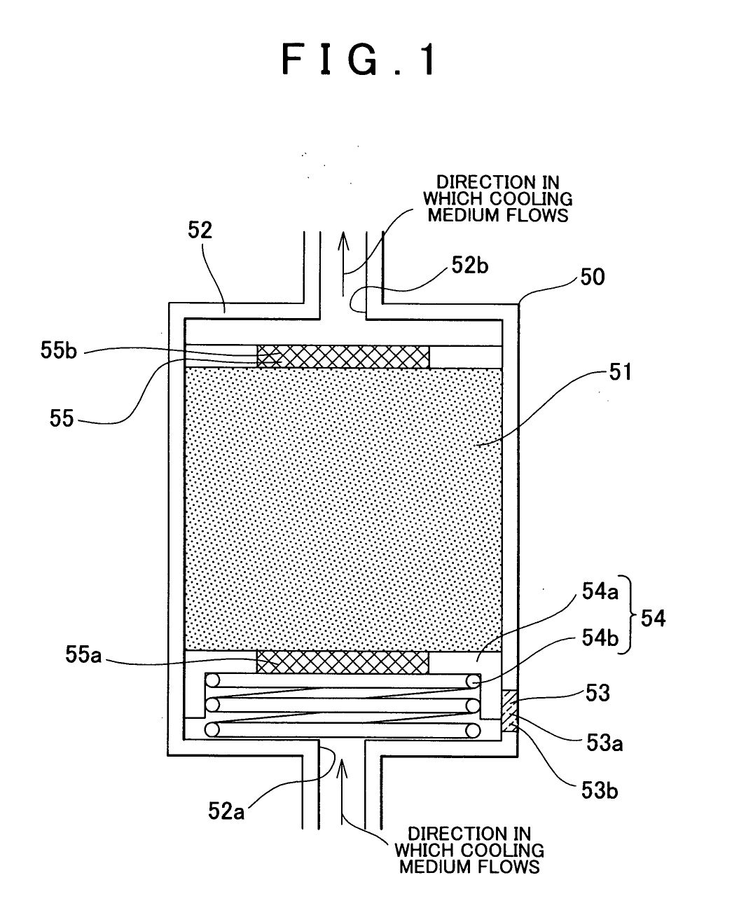

Hereafter, a cooling system for a fuel cell, according to a first embodiment will be described with reference to FIG. 1 and FIGS. 6 to 8.

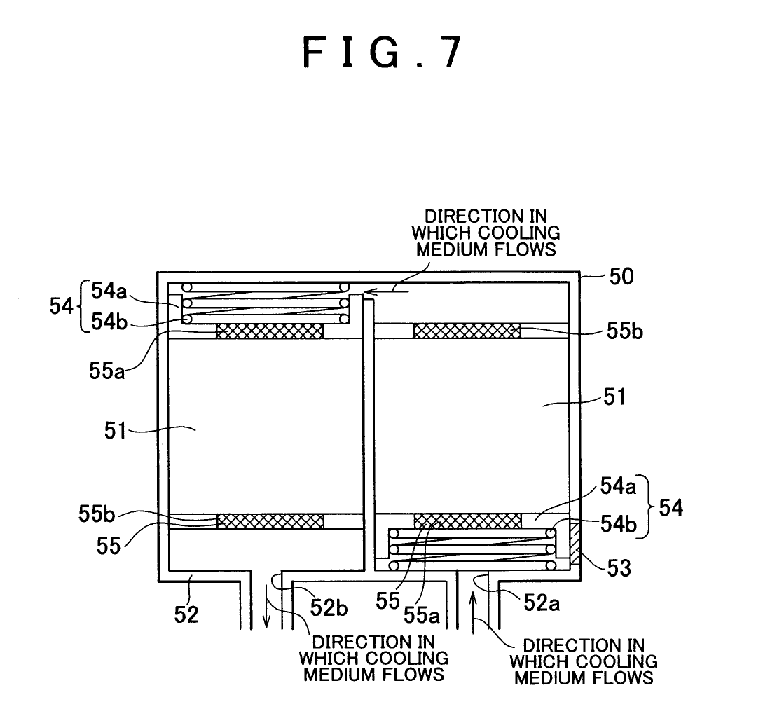

A fuel cell, e.g., a polymer electrolyte fuel cell, is constituted by stacking cells each of which includes a MEA (i.e., Membrane-Electrode Assembly) and a separator. The MEA has an electrolyte membrane interposed between an anode and a cathode. In order to suppress a temperature of the fuel cell from exceeding an allowable temperature due to heat generated by electric power generation reaction, a cooling medium (i.e., coolant) flows between the cells, and the fuel cell is thus cooled. As shown in FIG. 8, the cooling medium is circulated in a cooling system 10, and a temperature of the cooling medium is adjusted to an appropriate value. The cooling system 10 includes a main passage 20, and a bypass passage 30, and is provided with a fuel cell 40, a coolant tank 41, a circulating pump 42, a heat exchanger (i.e., radiator) 43, a selector valve (i.e., temperature induction valve) 44, a three-way valve 45, an electrical conductivity sensor 46, and an impurity removing device 50. The electrical conductivity sensor 46 transmits a signal corresponding to an electrical conductivity of the cooling medium flowing through the main passage 40 to a control device 60. The control device 60, which has received the signal, decides a quantity of the cooling medium flowing from the main passage 20 to the bypass passage 30 based on the electrical conductivity of the cooling medium obtained by the electrical conductivity sensor 46. The electrical conductivity sensor 46 does not determine a degree of deterioration of an after-mentioned impurity removing member 51 of the impurity removing device 50.

The impurity removing device 50 is provided in the bypass passage 30.

The impurity removing device 50 removes impurities in the cooling medium for the fuel cell 40. As shown in FIG. 1, the impurity removing device 50 includes the impurity removing member 51, a container 52 which houses the impurity removing member 51, a detecting device 53 which detects deterioration of the impurity removing member 51, and a pushing member 54. The impurity removing device 50 further includes a filter 55.

The impurity removing member 51 may be an ion exchange resin which reduces ion substances in the cooling medium, or may be a filter which removes dust in the cooling medium (e.g., dust from an inner wall contacting liquid flowing in a cooling passage, the pump, the heat exchanger (i.e., radiator), and the like). Hereafter, the case where the impurity removing member 51 is an ion exchange resin will be described.

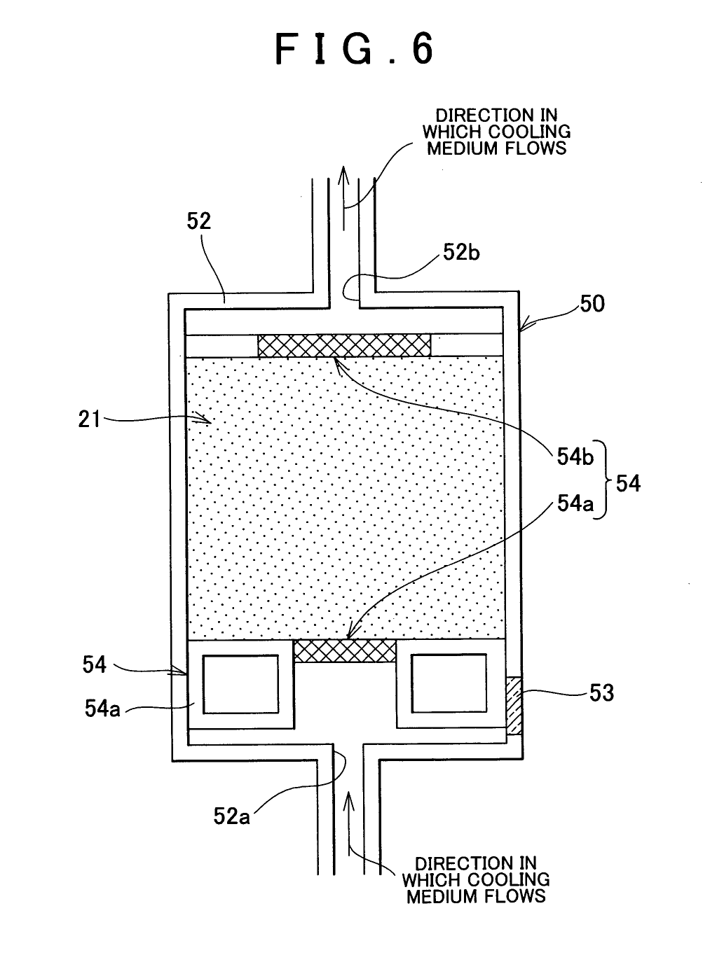

The impurity removing device 50 is used by vertically placing the container and making the cooling medium flow in the direction from bottom to top of the container 52. Note that, the impurity removing device 50 may be used; 1) by vertically placing the container 52 and making the cooling medium flow in the direction from top to bottom of the container 52, 2) by horizontally placing the container 52 and making the cooling medium flow from one of the right side and the left side of the container 52 to the other side, and 3) by vertically placing the container 52, introducing the cooling medium into the container 52 from the bottom, making the cooling medium U-turn in the container 52, and releasing the cooling medium from the bottom of the container 52, as shown in FIG. 7. Hereafter, with reference to FIG. 1, description will be made taking the case, where the impurity removing device 50 is used by vertically placing the container 52 and making the cooling medium flow in the direction from bottom to top of the container 52, as an example.

The impurity removing member 51 is formed by irregularly mixing granular anion resin and granular cation resin. The impurity removing member 51 is housed in the container 52 at a portion whose cross section is constant. Accordingly, a corner where the impurity removing member 51 cannot be used efficiently is prevented from being produced, and therefore the entire impurity removing member 51 can be used efficiently.

The container 52 has a cylindrical shape, and is provided with walls at the top and the bottom thereof. In the bottom wall, there is formed an inlet 52a through which the cooling medium flows in the container 52. In the top wall, there is formed an outlet 52b through which the cooling medium, that has flowed into the container 52, flows out of the container 52.

The detecting device 53 includes a display device 53a which indicates deterioration of the impurity removing member 51. The display device 53a is a transparent or translucent window member 53b formed in a side wall of the container 52. The window member 53b is formed in a portion of the side wall of the container 52, where a movable cap 54a of the pushing member 54 is positioned, or is formed in a portion of the side wall of the container 52, where the impurity removing member 51 is positioned.

The pushing member 54 is provided inside the container 52. The pushing member 54 contacts the end of the impurity removing member 51 on the upstream side in the direction in which the cooling medium flows, and an upstream side filter 55a provided on the upstream side of the impurity removing member 51 in the direction in which the cooling medium flows. Note that the pushing member 54 may contact only the upstream side filter 55a.

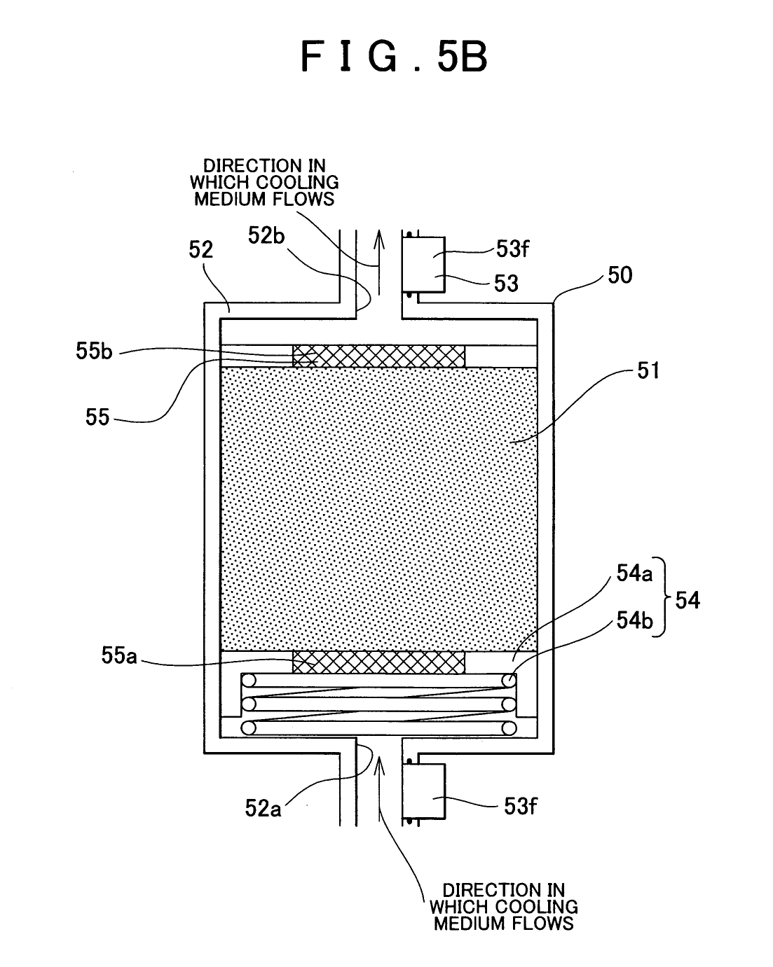

The pushing member 54 may includes; (A) the movable cap 54a which is movable in the container 52 in the direction in which the cooling medium flows, and an urging spring 54b which pushes the movable cap 54a to the downstream side in the direction in which the cooling medium flows as shown in FIG. 1, or (B) only the movable cap 54a which is movable in the container 52 in the direction in which the cooling medium flows as shown in FIG. 6.

In the case of (A) where the pushing member 54 includes the movable cap 54a and the urging spring 54b, the movable cap 54a pushes the impurity removing member 51 to the downstream side in the direction in which the cooling medium flows (i.e., upward in FIG. 1) using an urging force of the urging spring 54b.

In the case of (B) where the pushing member 54 includes only the movable cap 54a, the specific gravity of the movable cap 54a is made lower than the specific gravity of the cooling medium by employing e.g., a hollow movable cap as the movable cap 54a. By making the specific gravity of the movable cap 54a lower than the specific gravity of the cooling medium so as to allow the movable cap 54a to float toward the impurity removing member 51 at all times, the movable cap 54a pushes the impurity removing member 51 even when the urging spring 54b is not provided.

The movable cap 54a moves to the downstream side in the direction in which the cooling medium flows (i.e., upward in FIG. 1) in accordance with a change in size (shrinkage of the resin) due to deterioration of the impurity removing member 51.

The filter 55 is provided inside the container 52. The filter 55 includes the upstream side filter 55a positioned on the upstream side of the impurity removing member 51 in the direction in which the cooling medium flows, and a downstream side filter 55b position on the downstream side of the impurity removing member 51 in the direction in which the cooling medium flows.

The upstream side filter 55a is movable in the container 52 in the direction in which the cooling medium flows. The upstream side filter 55a is movable together with the movable cap 54a. Accordingly, even when the impurity removing member 51 shrinks or is deformed and the size thereof is changed, the upstream side filter 55a contacts the end of the impurity removing member 51 on the upstream side in the direction in which the cooling medium flows

The downstream side filter 55b is immovable with respect to the container 52.

Hereafter, effects of the first embodiment will be described.

When the electrical conductivity (detected by the electrical conductivity sensor 46) of the cooling medium flowing through the main passage 20 is “0” or substantially “0”, the quantity of the cooling medium flowing through the bypass passage 30 is “0” or small. Accordingly, passage resistance and pump loss are reduced. When the electrical conductivity of the cooling medium flowing through the main passage 20 increases, the quantity of the cooling medium flowing through the bypass passage 30 is increased and the ion concentration is reduced by the impurity removing device 50.

When the impurity removing member 51 deteriorates with use of the impurity removing device 50, the impurity removing member 51 shrinks and the color thereof changes.

In the first embodiment, the display device 53a is the transparent or translucent window member 53b. Therefore, when the window member 53b is formed in a portion of the side wall of the container 52, where the movable cap 54a is positioned, the amount of movement of the movable cap 54a in accordance with the shrinkage of the resin can be visually checked from the outside of the container 52. When the window member 53b is formed in a portion of the side wall of the container 52, where the impurity removing member 51 is positioned, the amount of shrinkage and a change in color of the impurity removing member 51 due to deterioration thereof can be visually checked from the outside of the container 52. Accordingly, whether the impurity removing member 52 has reached the end of its life (i.e., whether the impurity removing member 52 needs replacing) can be easily determined by visually checking whether the amount of movement of the movable cap 54a or the amount of shrinkage of the impurity removing member 51 has reached a predetermined value, or by visually checking whether the color of the impurity removing member 51 has changed to a predetermined color.

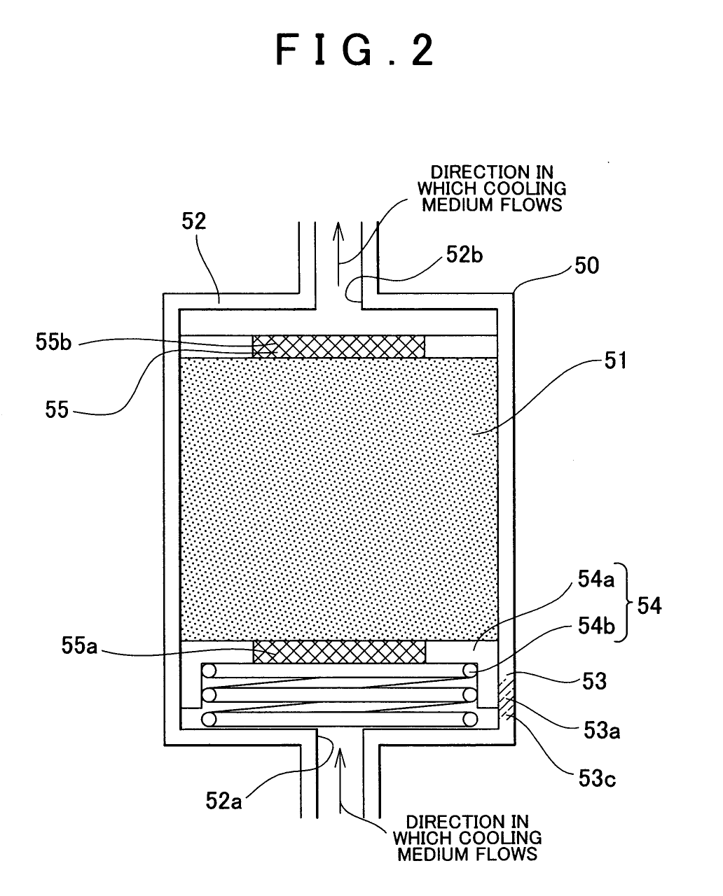

Hereafter, a cooling system for a fuel cell, according to a second embodiment will be described with reference to FIG. 2. Note that the same reference numerals will be assigned to the same portions as those in the first embodiment, and the description thereof will not be made.

In the second embodiment, the display device 53a constitutes at least part of the container 52, and is a transparent or translucent container wall 53c. The wall 53c may be formed in the entire container 52, or may be formed only in the side wall portion of the container 52.

Since the display device 53a is the wall 53c, the amount of shrinkage and the change in color of the impurity removing member 51 due to deterioration of the impurity removing member 51 housed in the container 52, and the amount of movement of the movable cap 54a due to shrinkage of the resin can be visually checked from the outside of the container 52. Therefore, whether the impurity removing member 51 has reached the end of its life (i.e., the impurity removing member 51 needs replacing) can be easily determined with a considerably simple structure and at a low cost.

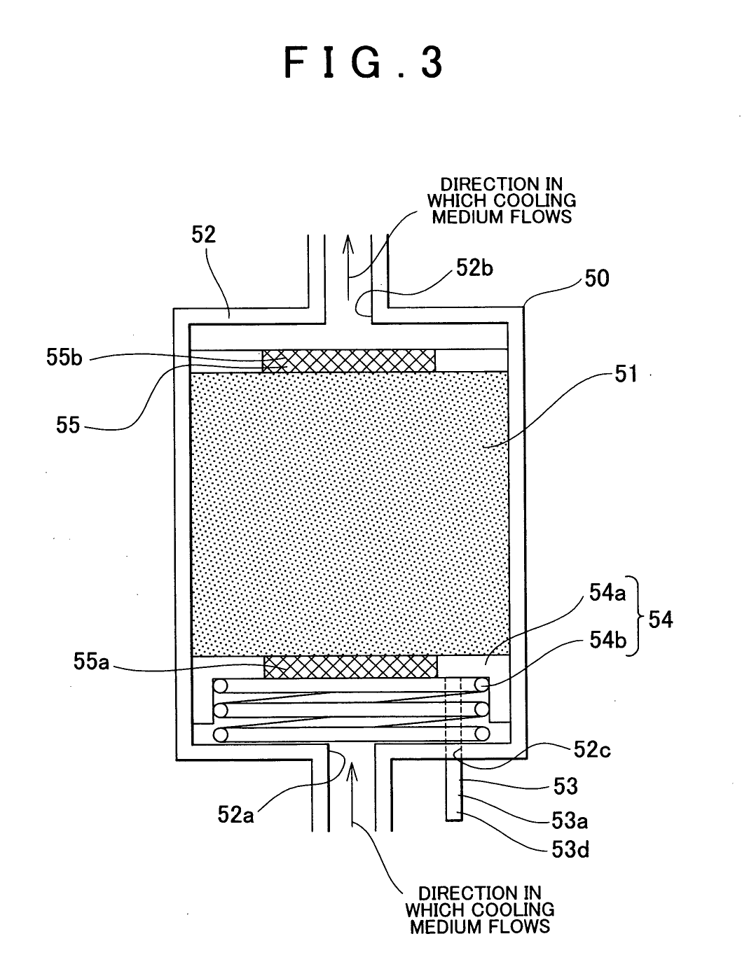

Hereinafter, a cooling system for a fuel cell, according to a third embodiment will be described with reference to FIG. 3. Note that the same reference numerals will be assigned to the same portions as those in the first embodiment, and the description thereof will not be made.

In the third embodiment, the display device 53a is a display member 53d which is movable with respect to the container 52 in accordance with deterioration of the impurity removing member 51. The display member 53d is, for example, a rod extending from the inside to the outside of the container 52. The rod-like display member 53d is attached to the movable cap 54 at an end portion positioned inside the container 52, and extends to the outside of the container 52 through a hole 52c formed in the container 52. The display member 53d is movable together with the movable cap 54a in the direction in which the cooling medium flows (i.e., upward in FIG. 3) with respect to the container 52 in accordance with a change in size of the ion exchange resin due to deterioration of the ion exchange resin. Between the display member 53d and the hole 52c, there is provided a seal member (not shown) for preventing the cooling medium in the container 52 from flowing out of the container 52 through the hole 52c.

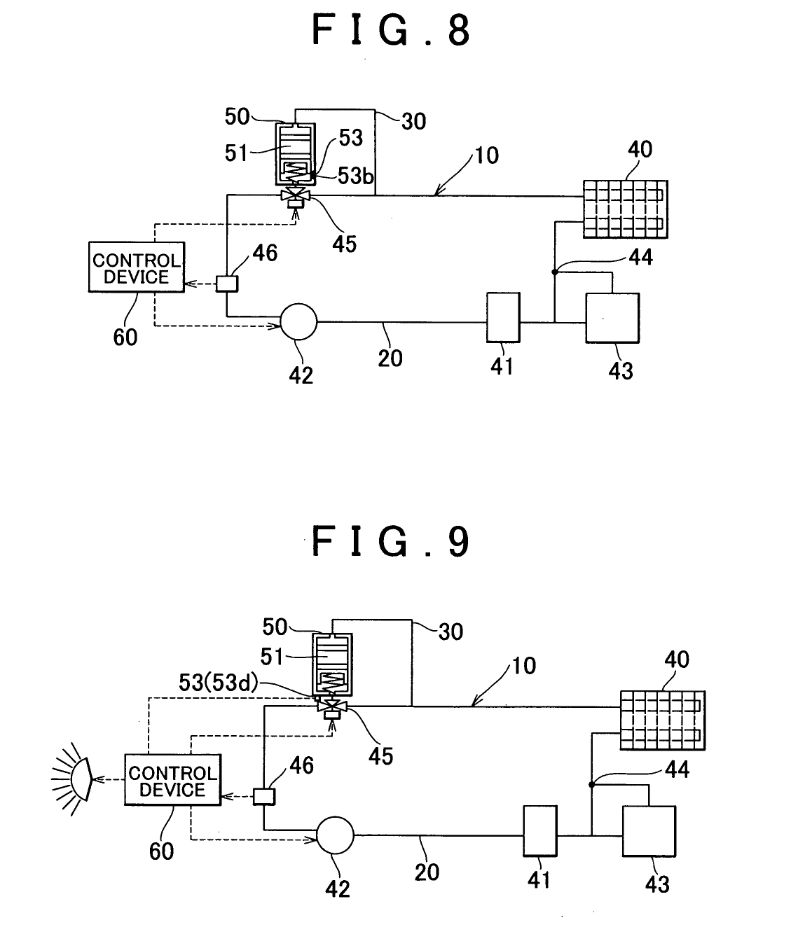

The display member 53d is attached to the movable cap 54a. Therefore, when the impurity removing member 51 shrinks due to deterioration thereof, the display member 53d moves together with the movable cap 54a to the downstream side in the direction in which the cooling medium flows with respect to the container 52 by the amount of shrinkage of the impurity removing member 51. Accordingly, whether the impurity removing member 51 has reached to the end of its life (i.e., whether the impurity removing member 51 needs replacing) can be easily determined by visually checking how much the display member 53d enters the container 52, from the outside of the container 52. In the third embodiment, the display member 53d is attached to the movable cap 54a. However, the display member 53d may be attached to the upstream side filter 55a, instead of to the movable cap 54a. In the third embodiment, whether the impurity removing member 51 has reached to the end of its life is determined by visually checking how much the display member 53d enters the container 52, from the outside of the container 52. However, instead of this, whether the impurity removing member 51 has reached to the end of its life may be easily determined by indicating a warning using a lamp or a display near a driver's seat, generating an alarm, or notifying a driver of the warning by voice, when the display member 53d enters the container 52 by an amount equal to or larger than a predetermined value, as shown in FIG. 9.

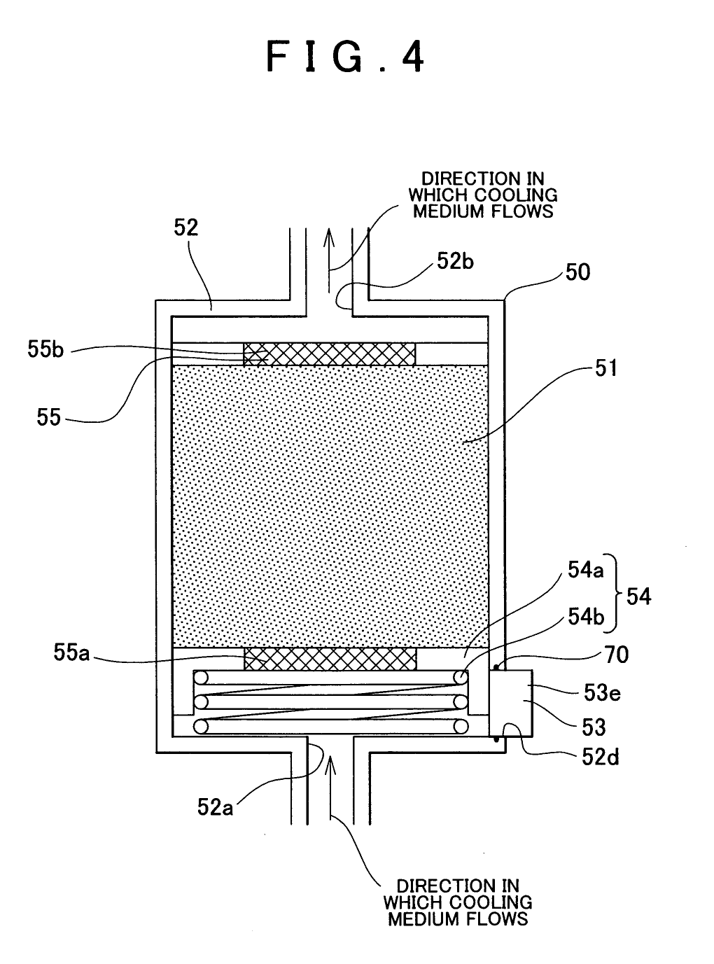

Hereafter, a cooling system for a fuel cell, according to a fourth embodiment will be described with reference to FIG. 4. Note that the same reference numerals will be assigned to the same portions as those in the first embodiment, and the description thereof will not be made.

In the fourth embodiment, the detecting device 53 includes a sensor 53e which detects at least one of a change in size of the impurity removing member 51 and a change in color of the impurity removing member 51 due to deterioration thereof.

The sensor 53e is attached to the side wall of the container 52 at the portion where the movable cap 54a is positioned, or the side wall of the container 52 at the portion where the impurity removing member 51 is positioned. The sensor 53e is attached to the side wall of the container 52 through a hole 52d for mounting the sensor, which is formed in the container 52. Between the sensor 53e and the hole 52d, there is provided a seal member 70 for preventing the cooling medium in the container 52 from flowing out of the container 52 through the hole 52d.

The detecting device 53 includes the sensor 53e. Therefore, when the sensor 53e is attached to a portion of the side wall of the container 52, where the movable cap 54a is positioned, the amount of movement of the movable cap 54a due to shrinkage of the impurity removing member 51 can be detected by the sensor 53e. When the sensor 53e is attached to a portion of the side wall of the container 53e, where the impurity removing member 51 is positioned, the changes in the amount of shrinkage and color of the impurity removing member 51 due to deterioration thereof can be detected by the sensor 53e. As a result, whether the impurity removing member 51 has reached the end of its life (i.e., whether the impurity removing member 51 needs replacing) can be easily determined.

When the amount of movement of the movable cap 54a becomes equal to or larger than a predetermined value, the amount of shrinkage of the impurity removing member 51 becomes equal to or larger than a predetermined value, or the color of the impurity removing member 51 is changed to a predetermined color, whether the impurity removing member 51 has reached to the end of its life (i.e., whether the impurity removing member 51 needs replacing) can be easily notified by indicating a warning using a lamp or a display near the driver's seat, generating an alarm, or notifying a driver of the warning by voice.

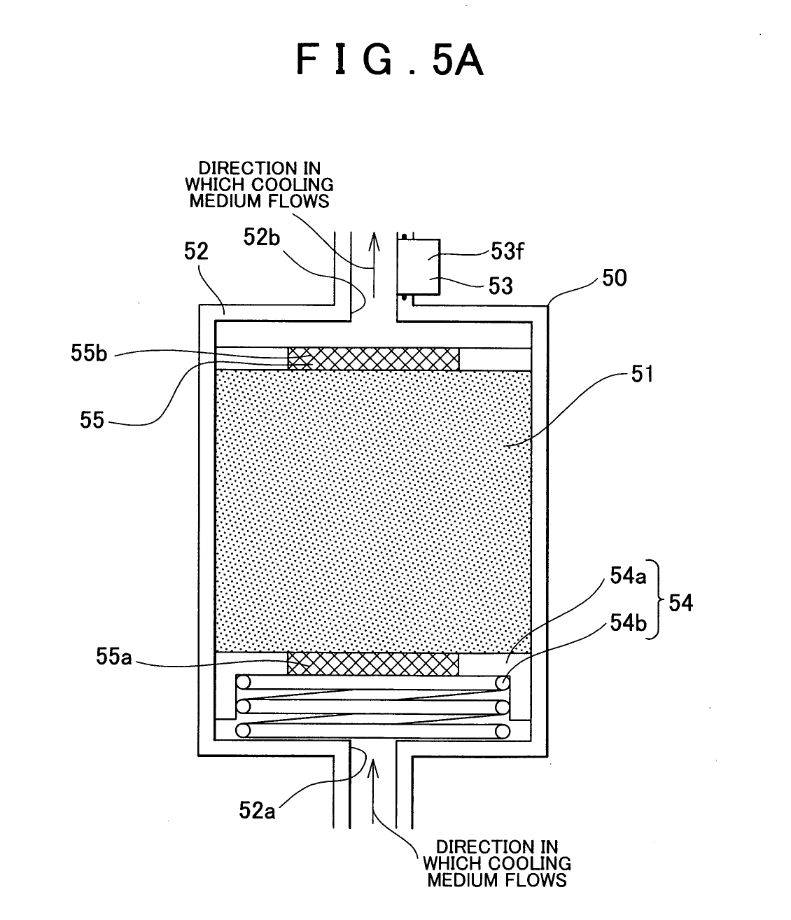

Hereafter, a cooling system for a fuel cell, according to a fifth embodiment will be described with reference to FIG. 5A. Note that the same reference numerals will be assigned to the same portions as those in the first embodiment, and the description thereof will not be made.

In the fifth embodiment, the detecting device 53 includes an electrical conductivity sensor 53f which can detect an ion concentration or an electrical conductivity of the cooling medium (i.e., coolant). The electrical conductivity sensor 53f is provided downstream from the container 52 in the direction in which the cooling medium flows.

By measuring the electrical conductivity of the cooling after the cooling medium passes through the impurity removing device 50, whether the impurity removing member 51 has reached the end of its life (i.e., whether the impurity removing member 51 needs replacing) can be determined.

In the fifth embodiment, the electrical conductivity sensor 53f is provided downstream from the container 52 in the direction in which the cooling medium flows. However, the electrical conductivity sensor 53f may be provided not only downstream from the container 52 but also upstream from the container 52 in the direction in which the cooling medium flows, as shown in FIG. 5B. When the electrical conductivity sensor 53f is provided upstream from the container 52, the deterioration state of the impurity removing member 51 can be determined by checking the degree of improvement in the electrical conductivity of the cooling medium between the inlet 52a and the outlet 52b of the container 52.

Note that, instead of the electrical conductivity sensor, a flow quantity, a pressure or a flow rate of the cooling medium in the coolant passage may be used.

In the above-mentioned embodiments, changes in both size and color of the impurity removing member due to deterioration thereof may be detected.

In the above-mentioned embodiments, the impurity removing device includes the pushing member which pushes the impurity removing member in a predetermined direction in the container. Therefore, even when the impurity removing member shrinks, the clearance produced due to the shrinkage can be removed.

The detecting device in the above-mentioned embodiments includes the display device which displays deterioration of the impurity removing member. Therefore, the degree of deterioration of the impurity removing member can be determined by checking the display device.

In the cooling system for a fuel cell shown in FIGS. 1, 6, and 7, the detecting device includes the transparent or translucent window member. Therefore, the changes in the amount of shrinkage and the color of the impurity removing member housed in the container can be checked from the outside of the container. When the impurity removing device includes the pushing member, the amount of movement of the pushing member in accordance with the shrinkage of the impurity removing member can be checked from the outside of the container. Accordingly, the degree of deterioration of the impurity removing member can be easily determined with a considerably simple structure and at a low cost.

In the cooling system for a fuel cell shown in FIG. 2, the detecting device includes the transparent or translucent wall. Therefore, the changes in the amount of shrinkage and the color of the impurity removing member housed in the container can be checked from the outside of the container. When the impurity removing device includes the pushing member, the amount of movement of the pushing member in accordance with the shrinkage of the impurity removing member can be visually checked from the outside of the container. Accordingly, the degree of deterioration of the impurity removing member can be easily determined with a considerably simple structure and at a low cost.

In the cooling system for a fuel cell in FIG. 3, the detecting device includes the display member which is movable with respect to the container in accordance with deterioration of the impurity removing device. Therefore, the amount of shrinkage of the impurity removing member housed in the container can be detected according to the amount of movement of the display member. Therefore, the degree of deterioration of the impurity removing member can be easily determined only by checking the display member.

The detecting device in FIG. 4 includes the sensor which detects at least one of the change in size of the impurity removing member and the change in color of the impurity removing member due to deterioration thereof. Therefore, the degree of deterioration of the impurity removing member can be determined by detecting the changes in size and color of the impurity removing member due to deterioration thereof.

The detecting device in FIGS. 5A and 5B includes the electrical conductivity sensor which detects the electrical conductivity of the cooling medium. Therefore, the degree of deterioration of the impurity removing member can be determined by measuring the electrical conductivity of the cooling medium for the fuel cell.

1. A cooling system for a fuel cell, comprising:
a cooling medium which cools the fuel cell;
an impurity removing member which removes impurities in the cooling medium;
a container which houses the impurity removing member; and
a detecting device which detects deterioration of the impurity removing member.

2. The cooling system according to claim 1, further comprising a pushing member which pushes the impurity removing member in a predetermined direction in the container.

3. The cooling system according to claim 2, wherein the pushing member includes a spring which pushes the impurity removing member in the predetermined direction.

4. The cooling system according to claim 2, wherein the pushing member is provided below the impurity removing member, and includes a member whose specific gravity is lower than specific gravity of the cooling medium.

5. The cooling system according to claim 1, wherein the detecting device detects at least one of a change in size of the impurity removing member and a change in color of the impurity removing member due to deterioration of the impurity removing member.

6. The cooling system according to claim 1, wherein the detecting device includes a display device which indicates deterioration of the impurity removing member.

7. The cooling system according to claim 6, wherein the display device includes a transparent or translucent window member which is formed in a wall of the container.

8. The cooling system according to claim 7, wherein the window member is formed in at least one of a portion of a side wall of the container, where the pushing member is positioned, and a portion of the side wall of the container, where the impurity removing member is positioned.

9. The cooling system according to claim 6, wherein the display device constitutes at least part of the container, and includes a transparent or translucent wall of the container.

10. The cooling system according to claim 9, wherein the wall is formed in at least one of a portion of a side wall of the container, where the pushing member is positioned, and a portion of the side wall of the container, where the impurity removing member is positioned.

11. The cooling system according to claim 6, wherein the display device includes a display member which is movable with respect to the container in accordance with deterioration of the impurity removing device.

12. The cooling system according to claim 11, wherein the impurity removing device includes a pushing member which pushes the impurity removing member in a predetermined direction in the container, and the display member is attached to the pushing member.

13. The cooling system according to claim 1, wherein the detecting device includes a sensor which detects at least one of a change in size of the impurity removing member and a change in color of the impurity removing member due to deterioration of the impurity removing member.

14. The cooling system according to claim 1, wherein the detecting device includes an electrical conductivity detecting device which detects an electrical conductivity of the cooling medium.

15. The cooling system according to claim 14, wherein the electrical conductivity detecting device includes a first sensor which detects the electrical conductivity of the cooling medium on a downstream side of the impurity removing member.

16. The cooling system according to claim 15, wherein the electrical conductivity detecting device further includes a second sensor which detects the electrical conductivity of the cooling medium on an upstream side of the impurity removing member, and detects deterioration of the impurity removing member based on a difference between the electrical conductivity detected by the first sensor and the electrical conductivity detected by the second sensor.

17. The cooling system according to claim 6, wherein the display device is a notifying device which makes a notification of deterioration of the impurity removing member when deterioration of the impurity removing member has been detected.

18. A cooling system for a fuel cell, comprising:
a cooling medium which cools the fuel cell;
impurity removing means for removing impurities in the cooling medium;
housing means for housing the impurity removing means; and
detecting means for detecting deterioration of the impurity removing means.

19. A method for detecting deterioration of an impurity removing member of a cooling system for a fuel cell, which includes cooling medium for cooling the fuel cell, comprising:
detecting deterioration of the impurity removing member by detecting a change in at least one of size of the impurity removing member, color of the impurity removing member, electrical conductivity of the cooling medium, a flow quantity of the cooling medium, a pressure of the cooling medium, and a flow rate of the cooling medium, which occurs due to deterioration of the impurity removing member.

20. The method according to claim 19, further comprising:
making a notification of deterioration of the impurity removing member when deterioration of the impurity removing member has been detected.
